(19) United States
(12) Patent Application Publication
(10) Pub. No.: US 2008/0305233 A1
(43) Pub. Date: Dec. 11, 2008

(54) Soy based bread product and method of preparation

(76) Inventor: Yoshihiko Akimoto, Tochigi (JP)

Correspondence Address: PATENT LAW & VENTURE GROUP, 2424 S.E. BRISTOL, SUITE 300, NEWPORT BEACH, CA, 92660, US

(21) Appl. No.: 11/811,193

(22) Filed: Jun. 7, 2007

(51) Int. Cl. A21D 10/02

(52) U.S. Cl. 426/551

(57) ABSTRACT

A method of preparing a soy based bread dough includes whipping a quantity of egg whites until frothy, and then slowly adding small quantities of sugar, while continuing the whipping, until reaching a specific gravity of not more than 0.5 in creating a meringue having bubbles. The method further includes, combining quantities of whole eggs, cooking oil, and milk, to create liquid ingredients mixture and sifting quantities of baking powder with soy flour, to create a dry ingredient mixture. Adding an appropriate quantity of the dry ingredient mixture to the liquid ingredient mixture to produce a preliminary dough having a light consistency, and then folding an appropriate quantity of the meringue into the preliminary dough, while preserving the bubbles that have formed in the meringue, to produce a ready to bake dough having an average specific gravity below 0.65.

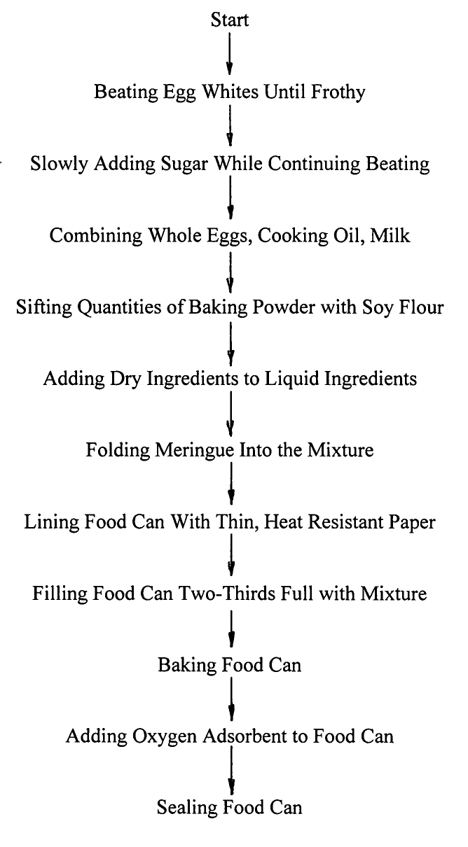

### BACKGROUND OF THE INVENTION

1. Field of the Present Disclosure

This disclosure relates generally to methods for, and ingredients used in making bread, and particularly to a method for making an unleavened bread that is light and airy, and further to a method for packaging such bread for long storage life.

2. Description of Related Art including information disclosed under 37 CFR 1.97 and 1.98

Thompson, U.S. Pat. No. 4,109,018 discloses a bread product which has superior nutritional characteristics regarding protein and roughage content and which exhibits a significant caloric reduction over standard white bread.

Watkins, U.S. Pat. No. 4,824,683, discloses a composition for use in making a low calorie and high fiber content bread product as a replacement of a portion of the conventional dough ingredients comprising a mixture of pre-gelatinized pea bran, pre-gelatinized oat bran and, optionally, soy flour, and the bread products thereof.

Abdelrahman, U.S. Pat. No. 4,892,762 discloses a process for the production of a baked product such as bread having reduced calories and a high fiber content wherein improved specific volume (cc/gm) is achieved comprising forming a flour base dough which contains an added amount of a treated soy polysaccharide material wherein the soy polysaccharide material is treated by hydration at a weight ratio of polysaccharide material to water of about 1:0.5 to 1:4 and heated at a temperature and time sufficient to improve the specific volume (cc/gm) of the baked product, as compared to the use of an untreated soy polysaccharide material.

Akimoto, U.S. Pat. No. 6,060,088, discloses a canning method for bread, including a stepwise procedure for producing a dough and baking a finished bread within a standard food can while enabling the bread to be stored for very long periods without spoiling or becoming inedible. The method includes sterilizing steps and means for easy removal of the bread from the can. A paper wrapper enables the bread to be maintained uniformly moist.

The related art described above discloses the use of soy for flour and for making bread. However, the prior art fails to disclose a method that results in a light and airy bread made from an unleavened flour. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

Conventionally, bread is made with a light and airy consistency. This is achieved by using a leavening agent. A leavening agent, sometimes called just leavening or leaven, is a substance used in dough and batters that causes a foaming action. The leavening agent reacts with moisture, heat, acidity, or other triggers to produce gas that becomes trapped as bubbles within the dough. Leavening may be achieved using a chemical agent such as baking soda, a bio-agent such as yeast, and by mechanical means such as by whipping or steaming. Leavened bread is desirable but unleavened breads are common around the world and include: matzo, tortilla, roti and chapati. The primary ingredient in bread is flour. Wheat, and to a lesser extent other grains containing gluten, are most often used to make bread because they result in a desirable elastic characteristic and in a highly expanded and aerated form.

The benefits of soy in the human diet are well known and soy food products are in great demand. However, soy does not react well to chemical or biological leavening agents in that it does not contain gluten and does not form a highly aerated or expended texture by the use of leavening agents alone. The present invention provides a solution to this problem in that it produces a well formed, expanded and tasty bread from soy flour. In this respect the present invention is a novel food product and method of making the food product.

A primary objective inherent in the above described product and method of preparation is to provide advantages not taught by the prior art.

Another objective is to provide a process for making a soy bread.

A further objective is to provide a soy bread that is light and easily consumed.

A still further objective is to package such a soy bread in a manner that may be advantageously stored over extended periods of time.

A still further objective is to provide a manner of producing a bread product that light in consistence without using a conventional leavening and wherein the flour used does not contain gluten.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE DRAWING

Illustrated in the accompanying drawing is a block diagram showing the steps taken in the present inventive method.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

Described now in detail is a method for preparing a canned baked bread. The process includes, first preparing a ready to bake (RTB) dough, then placing the RTB dough into open cans, and finally baking the RTB dough in the cans and then sealing the cans. Preferably the dough is made from soy flour, but it may be made from other food stuffs such as from any commercial seed or potato for instance. In this disclosure and attended claims, we refer to soy flour but it should understood that the term “soy” shall also take the meaning of any raw material food stuff from which a flour may be produced.

In preparing the RTB dough, the raw materials used are: egg whites, sugar, whole eggs, cooking oil, milk, and baking powder. The method steps include whipping the egg whites until frothy, and then slowly adding small quantities of the sugar until reaching a specific gravity of not more than 0.5 to create a meringue. Next, appropriate quantities of the whole eggs, the cooking oil, and the milk, i.e., the liquid ingredients, are combined. Then, appropriate quantities of the baking powder with the soy flour; i.e., the dry ingredients, are sifted. The dry ingredients are added to the liquid ingredients to produce a preliminary dough. Next, the meringue is folded into the preliminary dough carefully preserving bubbles that have formed in the meringue to produce the RTB dough. The average specific gravity of the RTB dough is maintained below 0.65.

After preparing the RTB dough, appropriate cans, such as #300 or #303 commercial food cans are lined with a thin, heat resistant paper, such as a glassine paper, and then filled to a height of approximately two-thirds full with the RTB dough, i.e., the RTB dough occupies approximately two-thirds of the volume of the container in which it is baked. Clearly, other size cans may be used depending on the ultimate use of the finished product as determined by the baker.

The open cans with the RTB dough in them are baked at 190° C. for 40 minutes to produce a baked soy bread. After baking, preferably, an oxygen adsorbent, such as a zeolite material, for instance, ferrierite, mordenite, faujasite or ZSM-5, is inserted into each can and the cans are immediately sealed using a standard commercial can sealing process well known in the art. The bread cools in the sealed can and sets due to its own heat in an exothermic process which causes the baked product to expand to fill the can. Oxygen within the can is drawn into the oxygen adsorbent so that it is mainly excluded and thereby enables prolonged storage life without spoilage of the bread. Of course different sized cans may be used in this process and then different temperature and, or, baking time will be appropriate and may be determined by simple experimentation by commercial bakers knowledgeable in this field. The canning process is more fully described in my prior patent, U.S. Pat. No. 6,060,088 issued Sep. 7, 1999 and which is incorporated by reference herein.

The specific gravity numbers of the dough and the dough mixture described above are critical to the success of the instant bread product and method.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A bread product having ingredients comprising: egg whites, sugar, whole eggs, a cooking oil, milk, and baking powder; wherein the egg whites and sugar are combined as a meringue having a specific gravity of not more than 0.5; the whole eggs, cooking oil, and milk are combined as liquid ingredients; and the baking powder and the soy flour are combined as dry ingredients; further wherein the dry ingredients and liquid ingredients are combined as a preliminary dough; and the meringue is folded into the preliminary dough as a ready to bake dough (RTB dough) having an average specific gravity below 0.65.

2. A method of preparing a soy based bread dough comprising the steps of:
a) whipping a quantity of egg whites until frothy, and then slowly adding small quantities of sugar, while continuing the whipping, until reaching a specific gravity of not more than 0.5 in creating a meringue having bubbles therein;
b) combining quantities of whole eggs, cooking oil, and milk, to create a liquid ingredients mixture;
c) sifting quantities of baking powder with soy flour, to create a dry ingredient mixture;
d) adding an appropriate quantity of the dry ingredient mixture to the liquid ingredient mixture to produce a preliminary dough having a light consistency; and
e) folding an appropriate quantity of the meringue into the preliminary dough, while preserving the bubbles that have formed in the meringue, to produce an RTB dough having an average specific gravity below 0.65.

3. The method of claim 2 further comprising the steps of:
a) lining a food can with a thin, heat resistant paper;
b) filling the food can two-thirds full with the RTB dough;
c) baking the food can at an appropriate time and temperature until the RTB dough therein is brown on an exposed upper surface and the interior of the RTB dough is selectively done; and
d) sealing the can.

4. The method of claim 3 further comprising the step of inserting an oxygen adsorbent into the food can prior to sealing the can.
